(19) United States
(12) Patent Application Publication
(10) Pub. No.: US 2019/0141807 A1
(43) Pub. Date: May 9, 2019

(54) DUAL DIMMING OF A LIGHTING ARRANGEMENT

(71) Applicant: CP IP Holdings Limited, Hong Kong (CN)

(72) Inventors: Dave Boulanger, Hong Kong (CN); Maciej Nowakowski, West Vancouver (CA)

(73) Assignee: CP IP Holdings Limited, Hong Kong (CN)

(21) Appl. No.: 16/162,865

(22) Filed: Oct. 17, 2018

Related U.S. Application Data
(60) Provisional application No. 62/573,181, filed on Oct. 17, 2017.

(51) Int. Cl. H05B 33/08

(52) U.S. Cl. CPC H05B 33/0845; H05B 33/0815

(57) ABSTRACT

A lighting arrangement can include a string of light emitting diodes (LEDs), a driver chip, a first switch, a bridge rectifier, and a second switch. The driver chip can be configured to direct current to the LEDs. The first switch can be configured to receive current from the grid for the driver chip. The first switch can be operable to change an amount of current directed to the driver chip to dim the LEDs. The bridge rectifier can be positioned between the first switch and the driver chip to convert alternating current to direct current. The second switch can be electrically connected with the driver chip whereby adjustment of the second switch results in a change in the amount of current directed to the LEDs from the driver chip and dim the LEDs. The first switch and the second switch are each concurrently operable to dim the LEDs.

### CROSS-REFERENCE TO RELATED APPLICATIONS

This application claims the benefit of U.S. Provisional Patent Application Ser. No. 62/573,181 for a DUAL DIMMING OF A LIGHTING ARRANGEMENT, filed on 17 Oct. 2017, which is hereby incorporated by reference in its entirety.

### BACKGROUND

### 1. Field

The present disclosure relates to dimming lighting circuits and luminaires.

### 2. Description of Related Prior Art

U.S. Pat. No. 9,699,851 discloses a dimming lighting circuit and luminaire. The dimming lighting circuit includes: a rectifier circuit; a phase detection circuit which outputs a dimming signal having a signal level corresponding to a conduction phase angle of an AC voltage; and a DC-DC converter which receives a DC voltage output from the rectifier circuit and supplies a light source with a DC current corresponding to the signal level of the dimming signal output from the phase detection circuit. If the conduction phase angle detected when the dimming lighting circuit receives the AC voltage at power-on is less than or equal to a predetermined angle, the phase detection circuit outputs, as the dimming signal, a substitute signal having a signal level corresponding to a conduction phase angle greater than the conduction phase angle of the AC voltage, for a predetermined time period.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A lighting arrangement can include a string of light emitting diodes, a driver chip, a first switch, a bridge rectifier, and a second switch. The driver chip can be configured to direct a variable level of current to the string of light emitting diodes. The first switch can be configured to receive current from the grid and be interconnected with the driver chip. The first switch can be operable to change an amount of current directed to the driver chip whereby the amount of current directed to the string of light emitting diodes is changed and the string of light emitting diodes is dimmable. The bridge rectifier can be positioned between the first switch and the driver chip and can be configured to convert alternating current from the first switch to direct current received by the driver chip. The second switch can be electrically connected with the driver chip whereby adjustment of the second switch results in a change in the amount of current directed to the string of light emitting diodes from the driver chip and the string of light emitting diodes is dimmable. The first switch and the second switch are each concurrently operable to dim the light emitting diodes of the string of light emitting diodes.

### BRIEF DESCRIPTION OF THE DRAWINGS

The detailed description set forth below references the following drawings:

FIG. 1A is a circuit schematic of a driving and dimming circuit for a luminaire according to an exemplary embodiment of the present disclosure;

FIG. 1B is a circuit schematic of a luminaire according to an exemplary embodiment of the present disclosure; and

FIG. 2 is a detailed schematic of a portion of the circuit shown in FIG. 1A.

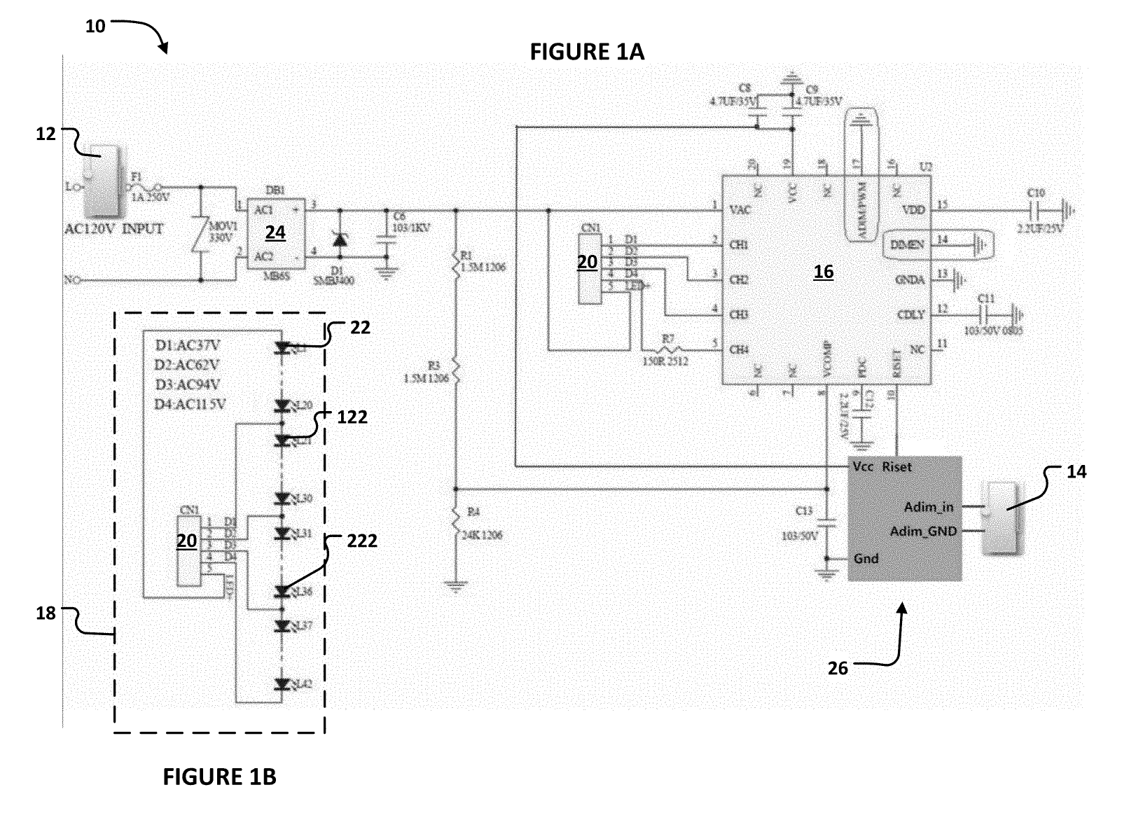

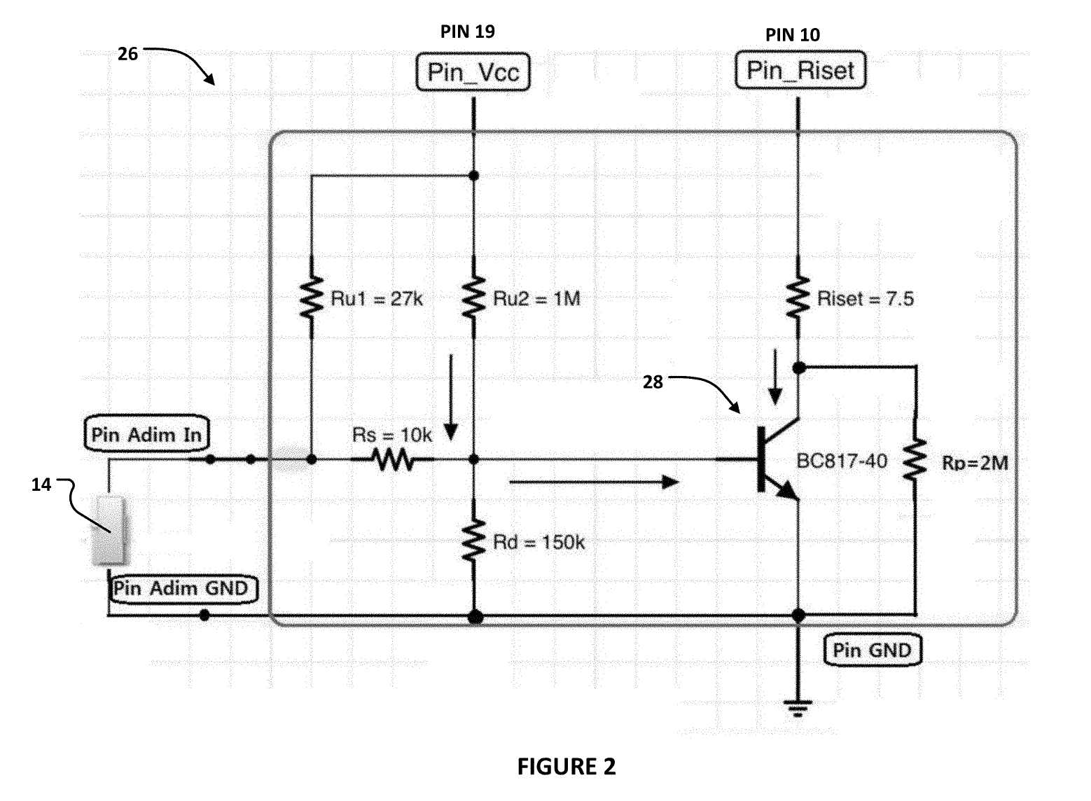

### DETAILED DESCRIPTION

The present disclosure, as demonstrated by the exemplary embodiment described below, can provide a lighting arrangement or luminaire that can include dual approaches to dimming. A dual dimming circuit is referenced at 10. The dual dimming circuit 10 includes a first dimming switch 12, a second dimming switch 14, and a driver chip 16. The first dimming switch 12 can receive AC power/current from the grid and can be mounted in a wall. As will be discussed in greater detail below, DC can flow through the second dimming switch 14. The exemplary driver chip is an SW5903 chip. The dual dimming circuit 10, receiving AC from the switch 12, can be connected to or be integrated with a luminaire 18 (shown schematically) of the lighting arrangement. The luminaire 18 houses a string of light emitting diodes (LEDs) 22, 122, 222. The second dimming switch 14 could be mounted on the luminaire 18. A connector 20 can interconnect the driver chip 16 with the plurality of LEDs 22, 122, 222.

Referring again to the dual dimming circuit 10, a bridge rectifier 24 can be positioned between the switch 12 and the chip 16. DC current can thus be directed to the chip 16 through pin 1. The chip 16 can direct current to the LEDs 22, 122, 222 through pins 2-5. Resistors R1, R3, and R4 can serve as voltage dividers. Through pin 8, the chip 16 can monitor voltage.

The first dimming switch 12 is a TRIAC dimmer. The second dimming switch 14 is a 0-10V dimming. The second dimming switch 14 is interconnected to the dual dimming circuit 10 through a portion of the dual dimming circuit 10 referenced at 26. Circuit portion 26 receives input from pins 19 and 10 of the chip 16. The input from pin 19 is V_{cc} and the input from pin 10 can be the same level of input received by the LEDs 22, 122, 222. The second dimming switch 14 allows the user to control dimming by varying the amount of current directed to the base of the BJT 28. BJT 28 is thus acting as a variable resistor. The chip 16 changes the level of current directed to the LEDs 22, 122, 222 in response to the level of current directed out of pin 10. A user can therefore effectuate dimming by either switch 12 or switch 14.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed is:

1. A lighting arrangement comprising:
a string of light emitting diodes;
a driver chip configured to direct a variable level of current to said string of light emitting diodes;
a first switch configured to receive current from the grid and interconnected with said driver chip, said first switch operable to change an amount of current directed to said driver chip whereby the amount of current directed to said string of light emitting diodes is changed and said string of light emitting diodes is dimmable;
a bridge rectifier positioned between said first switch and said driver chip and configured to convert alternating current from said first switch to direct current received by said driver chip; and
a second switch electrically connected with said driver chip whereby adjustment of said second switch results in a change in the amount of current directed to said string of light emitting diodes from said driver chip and said string of light emitting diodes is dimmable, said first switch and said second switch each concurrently operable to dim said light emitting diodes of said string of light emitting diodes.

2. The lighting arrangement of claim 1 wherein said first switch is further defined as a TRIAC dimmer switch.

3. The lighting arrangement of claim 1 wherein said second switch receives a current from said driver circuit and said driver circuit is further defined as configured to detect a level of said current directed to said second switch.

4. The lighting arrangement of claim 3 wherein said second switch defines and internal, variable resistance, such that said current directed to said second switch from said driver chip is variable.

5. The lighting arrangement of claim 4 wherein said level of current directed to said string of light emitting diodes from said driver chip is the same as a level of said current directed to said second switch from said driver chip.

6. The lighting arrangement of claim 4 further comprising:
a luminaire housing said string of light emitting diodes, wherein said first switch is mounted to a wall and said second switch is mounted on said luminaire.
